(19) United States
(12) Patent Application Publication
(10) Pub. No.: US 2007/0005579 A1
(43) Pub. Date: Jan. 4, 2007

(54) Query based synchronization

(75) Inventors: Jasjit Singh Grewal, Sammamish, WA (US); Andrey A. Zaytsev, Sammamish, WA (US); Ilana Rae Smith, Bellevue, WA (US); Andriy Smertin, Bellevue, WA (US); Ramaprasad Hari Prasad, Redmond, WA (US); Jacob Johansen, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/289,867

(22) Filed: Nov. 30, 2005

Related U.S. Application Data
(60) Provisional application No. 60/696,487, filed on Jul. 1, 2005.

(51) Int. Cl. G06F 17/30

(52) U.S. Cl. 707/3

(57) ABSTRACT

A method, system and user interface are disclosed for a query based system to synchronize an offline application with an online application. The queries may be user definable to identify only the limited data that the offline user desires to be updated and data satisfying the queries may be stored in a synchronization file on the online application. Once a synchronization file has been successfully communicated to the offline device, the synchronization file and a status file of the offline application on the online system may be updated to reflect the successful update.

### QUERY BASED SYNCHRONIZATION

This is a non-provisional of U.S. Provisional Application Ser. No. 60/696,487, filed Jul. 1, 2005, the entire disclosure of which is incorporated herein by reference.

### BACKGROUND

As the world becomes more mobile, fewer and fewer users of computer systems and applications are permanently connected to a network. More often, users occasionally log into a desired network and synchronize the offline system with the online system. Other situations may have a user with wireless access to a network. The wireless connection may be of varying quality and varying speed, including complete drop offs of the wireless network. In both wired and wireless situations, the amount of data that is present on the online system and not present on the offline system may be enormous and synchronization of this data may take a significant amount of time, even with a high speed connection. Further, an offline user may only wish to receive updated data for certain applications and may not have a need for all the data that is considered new on the online system.

### SUMMARY

A method, system and user interface are disclosed for a query based system to synchronize an offline application with an online application. The queries may be user definable to identify only the limited data that the offline user desires to be updated. The queries may be translated into SQL queries which may executed against a CRM database, for example. The online system may keep a file, which may be a database table, of data that satisfies the user defined queries of data that the offline user desires to be updated. The update file may be communicated to the offline device under a variety of conditions, such as when the offline application establishes communication to the online application, during a given time interval or whenever a present amount of new data is generated on the online application. The synchronization file may be separated into packets of an appropriate size depending on the method of communication. In addition, a file may be kept on the online system that tracks the current update status of the offline system. Once a synchronization file has been successfully communicated to the offline device, the synchronization file and the status file of the offline application on the online system may be updated to reflect this update.

### FIGURES

FIG. 1 may be an illustration of a computer system upon which the method, system and user interface may operate;

FIG. 2 may be an illustration of a method of query based synchronization in accordance with the claims;

FIG. 3 may be an illustration of query creation display;

FIG. 4 may be an illustration of additional detail that can be obtained by selecting a query; and

FIG. 5 may be an illustration of additional conditions that may be created in selecting the data to be synchronized.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

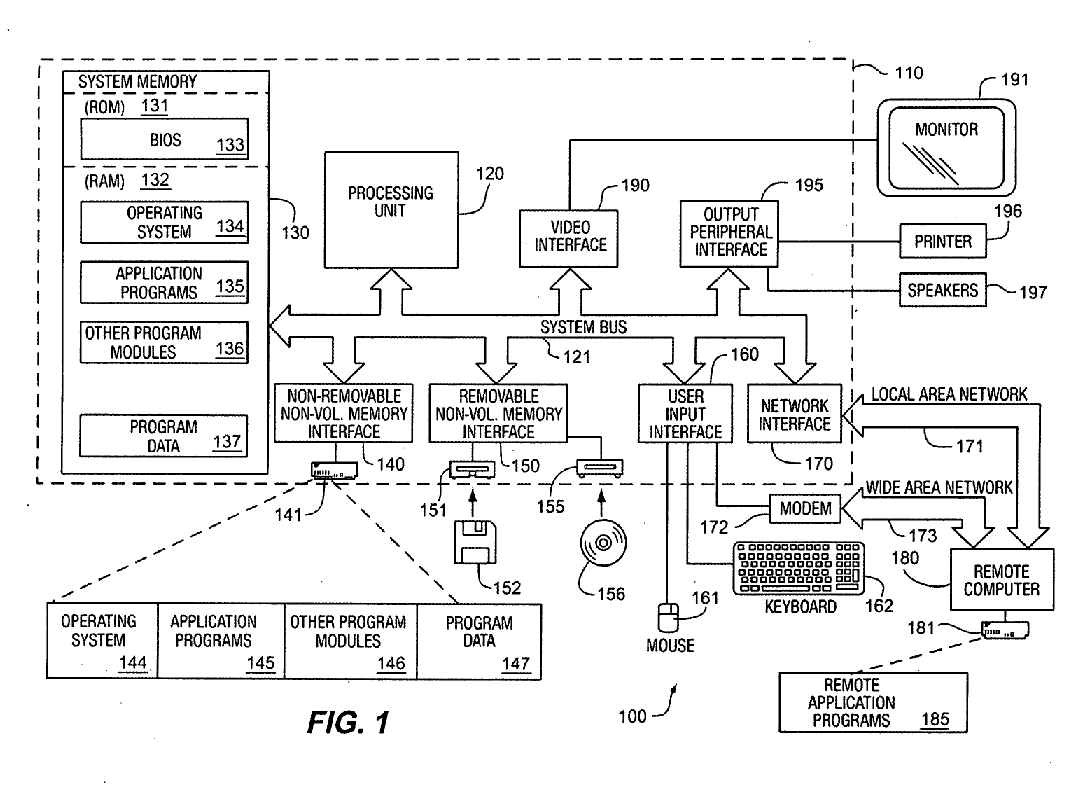

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

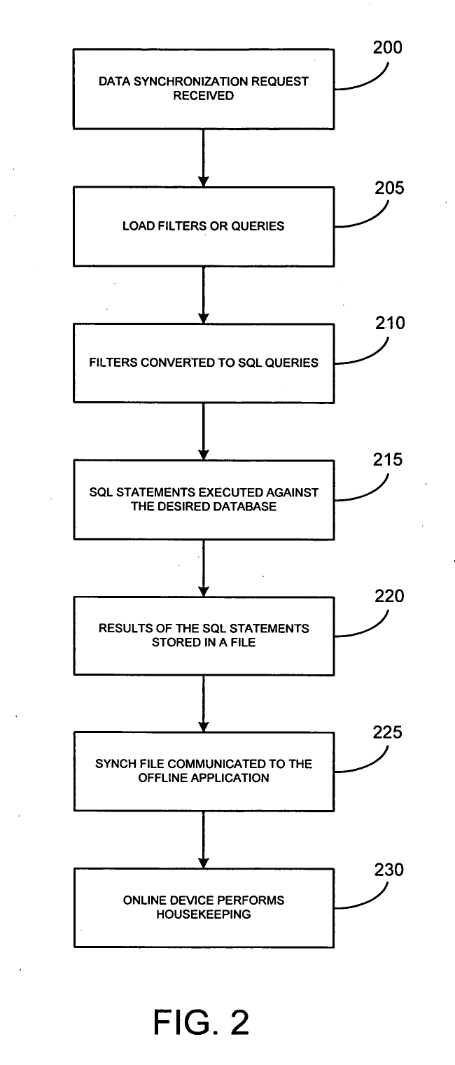

FIG. 2 may be an illustration of a method in accordance with the claims. At block 200, a data synchronization request may be received. The data synchronization request may be received in a variety of ways. The synchronization may be based on a period of time. For example, if the offline device can be reached through a wireless connection, a data synchronization request may be generated periodically so data may be transmitted periodically. The synchronization request may also be generated by a user. For example, a user of a customer relationship management system may login from a remote computer and the login may trigger the data synchronization request. In yet another example, the modification of certain data may be a trigger of the data synchronization request. Another example may be that when a predetermined amount of new data has been collected, it may trigger a synchronization request. Certainly, other triggers are possible.

At block 205, the method may load filters or queries. The queries may be defined by the user. An offline user may not need to receive all the data that has been added to an on-line application since the last time the offline user was online. Accordingly, the user may be able to define queries that will obtain data that the offline user desires to have updated. For example, a user may desire to know from a customer relationship management (“CRM”) application when a customer of that user has placed a new order. The user may not need to know of every order that the corporation has received, but just those orders placed by his or her customers. The user may be able to define a query that will return all the orders placed by his or her customers since the offline user last received an update. An even broader query may be to update all information on the offline device with all the information on the online device that has been added to the online device since the last update of the offline device. The variety and amount of queries that a user can define is virtually limitless. As just another example, a CRM offline user may create a query to obtain data on any new orders that are placed that are greater than a threshold, such as $50 million. The information can be any desired information including customer relationship management system (CRM) information that usually is too large to be synchronized.

In another embodiment, the query may be selected from a plurality of predefined queries. The queries may be provided by the software vendor or may be templates created by another user. These predefined queries also may be modified by users to further fit their needs.

Queries may be created in a traditional top-down fashion or in a bottom up fashion. The bottom-up query may allow offline data based on a hierarchy to be refined more simply. For example, instead of creating top-level query that looks something like “Give me all accounts that I own and any records associated with that account. But I don't want any sales orders older than a year old, closed service incidents . . . ”, the user can define what accounts the user wants, and use clauses in the queries of the child records based on the presence of parent records. For example, the account query would say “Give me accounts that I own”. Then the sales order query would say “Give me sales orders that are less than a year older where I'm also downloading the parent account”.

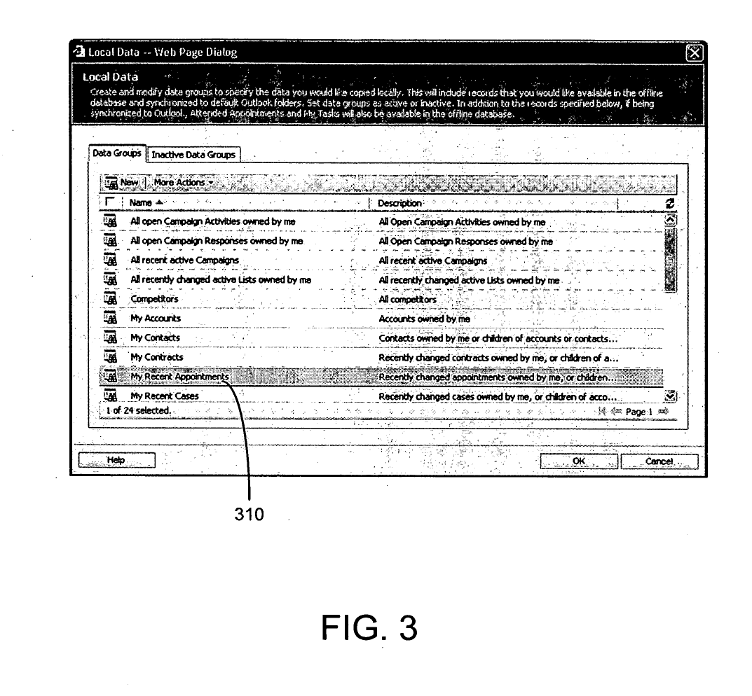

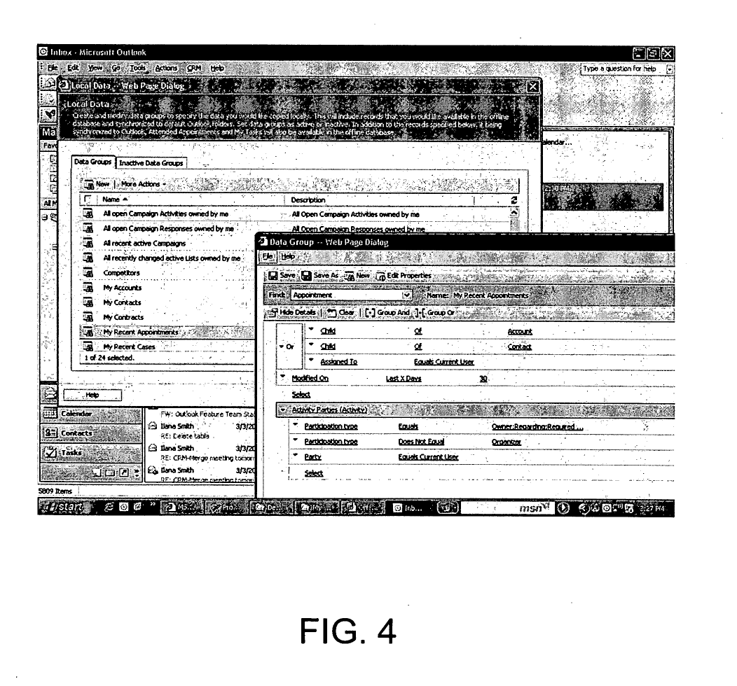

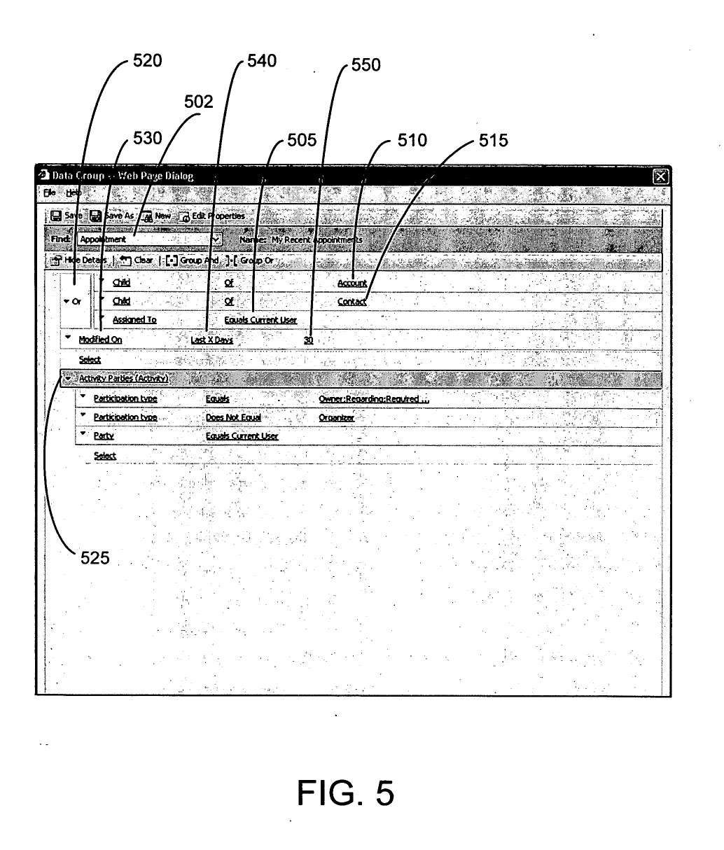

As illustrated in FIG. 3, the queries may be created using a simple user interface that does not require a user to know any programming language or SQL code. For example, a list of queries may be displayed 310 and can be selected to be part of future synchronizations. FIG. 4 may illustrate a more detailed screen that may pop-up and allow the selected query 310 from FIG. 3 to be further modified. FIG. 5 may be a display of the pop-up window displayed in FIG. 4 FIG. 5 may illustrate that this user (505) desires to have appointments (502) owned by the user (505), plus any appointments related to accounts (510) or (520) the users contacts (515) that the user is downloading, and where the user is an attendee at the appointment (525) that have been modified (530) in the last (540) 30 days (550) be synchronized. Certainly, there are always an unlimited number of queries that a user may create. In another example, a wizard or new window may be displayed which assists a user in designing a query.

The queries may be defined for each user of the application. For example, each salesperson for Company A may have their own queries. In addition, the queries can be further broken down. For example, a salesperson may want to be updated about all sales to customer A that were over $50 million but may want to be updated on all sales to customer B that were over $50.

Referring again to FIG. 2, at block 210, the filters may be converted to SQL queries. As many application users are not skilled in creating SQL queries, the method may perform this transformation automatically. The queries may be created using a fixed set of options (such as known names, and known decisions such as greater than, less than, etc.). The SQL queries may be fetch commands issued against a database, such as a CRM database.

At block 215, the SQL statements may be executed against the desired database. As stated previously, the database may be a CRM database and the SQL statements may be SQL translations of the queries created by the user at block 205. Other manners of obtaining the desired data and other sources of data are possible.

At block 220, the results of the SQL statements may be stored in a file which may be a synchronization file. As an example, if the query of block 205 requested all new orders placed by customers of an offline salesperson, all the new orders placed by the customer of the offline sales associate since the last synchronization may be stored in a file. In one example, the file may be a table but the synchronization file can take on virtually any format so long as both the online and offline application understand the data in the file. If the synchronization file is a table, traditional SQL statements may be used to create the table. For example, a merge command may be used to add in deleted records and updated records to the synchronization file. In addition, an insert command may be used to insert new records into the synchronization file.

At block 225, the synchronization file may be communicated to the offline application. The offline application may have a variety of forms, such as a web based application that logs into a network, a wireless device that receives data in a one way and/or a two way manner, a cell phone type device, or any other electronic device that can communicate with the online device. There are a variety of ways to communicate between an online device and an offline device when the offline device is brought online. Protocols and standards are already in place to control communication between online devices and offline devices that are brought online. For example, if the offline device is using the internet, common methods include http, TCP/IP, ftp, etc.

As stated previously, the synchronization file may be separated into packages of a size that is appropriate for the method of communicating with the offline device. For example, if the offline device is connected to a 10 megabit Ethernet network that also is connected to the online device, the size of the synchronization file packages may be of little concern. However, if the offline device is connected via a wireless link at low bandwidth, such as 10 kb per second, and low quality where packages may be easily lost, it may be appropriate to use packages of a smaller size. The size of the package may be preset or dynamically modified by the application, may be modified by the user or may be modified by a template.

At block 230, once the synchronization file has been communicated to the offline device, the online device may perform some housekeeping. The synchronization file may be emptied of all the entries that were communicated to the offline device. In addition, a status file of the offline device may be updated. The status file may keep track of the state of the offline device such as the last time a synchronization file was communicated. In addition, there may be a check that the synchronization file was successfully received by the offline device.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of defining data that is synchronized between an online device and an offline device comprising:
creating a query to select a subset of data from a data source;
storing the subset of data in a memory;
communicating the subset of data to the offline device; and
updating on the online device an offline device status file wherein the offline device status file stores the update status of the offline device.

2. The method of claim 1, further comprising selecting a query from a plurality of predefined queries.

3. The method of claim 1, further comprising using the queries to collect data that is present on the online device and that not present on the offline device.

4. The method of claim 1, further comprising using the queries to compare the data on the online device to the data in the offline device status file and updating the offline device with the data that is new on the online device and not indicated as being present on the offline device by the offline device status file.

5. The method of claim 1, wherein the data is customer relationship management data.

6. The method of claim 1, further comprising translating the queries into fetch statements that are executed against a CRM database.

7. The method of claim 1, further comprising storing the selected subset of data in a synchronization file.

8. The method of claim 7, further comprising communicating the synchronization file to the offline device immediately when updated data is added to the synchronization file.

9. The method of claim 7, further comprising breaking the synchronization file into packages of a size that are user modifiable.

10. The method of claim 7, further comprising breaking the synchronization file into packages of a size that is appropriate in view of the communication channel used.

11. The method of claim 7, further comprising updating the synchronization file to indicate that data delivered to the offline device is no longer new data for the offline device when the synchronization file has been successfully communicated to the offline device.

12. The method of claim 1, further comprising allowing different queries to be created for different entities.

13. The method of claim 1, wherein the offline status file is a database table.

14. The method of claim 13, wherein creating the offline status file comprises merging deleted records, merging updated records and merging inserted records in the database table.

15. The method of claim 1, further comprising allowing the creation of individual queries for specific users.

16. A computer readable medium adapted to store computer executable code to create queries to identify data to be synchronized between an online device and an offline device wherein the computer executable code comprises computer code to:
create a query to select a subset of data from a data source wherein the query compares the data on the online device to the data in an offline device status file wherein the offline device status file stores the update status of the offline device;
store the subset of data in a synchronization file;
communicate the synchronization file to the offline device thereby updating the offline device with the data that is not present in the offline device as indicated by the offline device status file; and
update on the online device the offline device status file.

17. The computer readable medium of claim 16, further comprising computer code to update the synchronization file to indicate that the data in the synchronization file was delivered to the offline device when the synchronization file has been successfully communicated to the offline device.

18. The computer readable medium of claim 16, further comprising computer code to break the synchronization file into packages of a size that are appropriate in view of the communication channel used.

19. A computing apparatus, comprising:
a display unit that is capable of generating video images;
an input device;
a processing apparatus operatively coupled to said display unit and said input device, said processing apparatus comprising a processor and a memory operatively coupled to said processor,
a network interface connected to a network and to the processing apparatus;
said processing apparatus being programmed to:
create a query to select a subset of data from a data source wherein the query compares the data on the online device to the data in an offline device status file wherein the offline device status file stores the update status of the offline device;
store the subset of data in a synchronization file;
communicate the synchronization file to the offline device thereby updating the offline device with the data that is indicated as not being present on the offline device by the offline device status file;
update on the online device the offline device status file; and
update the synchronization file to indicate that the selected data has been delivered to the offline device when the synchronization file has been successfully communicated to the offline device.

20. The computing apparatus of claim 19, further comprising updating the synchronization file to break the synchronization file into packages of a size that are appropriate in view of the communication channel used.
